(19) United States
(12) Patent Application Publication
(10) Pub. No.: US 2016/0088119 A1
(43) Pub. Date: Mar. 24, 2016

(54) RELAY DEVICE AND RELAY METHOD

(71) Applicant: FUJITSU LIMITED, Kawasaki-shi (JP)

(72) Inventors: Fumi Iikura, Shinagawa (JP); YASUHIDE MATSUMOTO, Kawasaki (JP)

(73) Assignee: FUJITSU LIMITED, Kawasaki-shi (JP)

(21) Appl. No.: 14/960,062

(22) Filed: Dec. 4, 2015

Related U.S. Application Data
(63) Continuation of application No. PCT/JP2013/066274, filed on Jun. 12, 2013.

(51) Int. Cl. H04L 29/08; H04L 12/931

(52) U.S. Cl. CPC H04L 67/2871; H04L 67/288; H04L 49/70

(57) ABSTRACT

A relay device that is disposed between a server device and a client device and that relays a request information, comprises a storage section that stores a past processing execution completion time and stipulation information; a reception section that receives the request information; and a computation section that computes a processing execution completion time needed for the server device to execute the specific processing according to the request information received by the reception section, based on: a relationship equation indicating a relationship between the stipulated information stipulating the contents of the specific processing, a coefficient, and the processing execution completion time needed for the server device to complete execution of the specific processing; the past processing execution completion time and the stipulation information stored in the storage section; and the stipulation information included in the request information received from the reception section.

### CROSS-REFERENCE TO RELATED APPLICATION

This application is a continuation application of International Application No. PCT/JP2013/066274, filed on Jun. 12, 2013, the entire contents of which are incorporated herein by reference.

### FIELD

A certain aspect of embodiments discussed herein is related to a relay device and a relay method.

### BACKGROUND

Conventionally, users having their own private cloud have used virtual machines (VMs) created on a server inside the private cloud in order to analyze data using VMs. However, sometimes large volumes of data are not analyzed in a short period of time using only a VM created on a server in a private cloud. It has therefore become common practice to also create VMs on servers of plural public clouds.

When generating a VM on a server in the cloud, the client device can request generation of a VM using a method common to each cloud by using an application program interface (API) common to the public cloud and the private cloud. When an API is used to generate a VM on a server in a public cloud in this manner, the client device can manage execution of the VM using the API. The client device can thus link the VMs in the public cloud and the private cloud using the API, and can analyze large volumes of data using the linked VMs. Since the API is common to the public cloud and the private cloud, using API enables the client device to flexibly expand and migrate the VMs. For example, in cases in which the need arises to analyze a larger volume of data but a VM is not created on a server in the current public cloud, the client device can create a VM on a server in another public cloud using the API.

The VMs set in each cloud are then connected to each other through a virtual private network (VPN). This thereby enables the client device to securely analyze large volumes of data using the VMs.

However, in the private cloud, the client device can ascertain VM generation capabilities for generating VMs on a server. Thus, the client device can predict the time to create a VM from the processing volume for VM generation and the processing capacity of the server on which the VM is to be created.

### RELATED PATENT DOCUMENTS

Patent Document 1: Japanese Patent Application Laid-open (JP-A) No. 2008-217302

Patent Document 2: JP-A No. 2011-192184

### SUMMARY

According to an aspect of the embodiments, a relay device is disposed between a server device, that executes specific processing according to request information including stipulation information stipulating contents of the specific processing, and a client device, that issues the request information, and that relays the request information. The relay device includes: a storage section that stores a past processing execution completion time needed for the server device to complete execution of the specific processing, and stipulation information stipulating the contents of the specific processing corresponding to the past execution completion time; a reception section that receives the request information; and a computation section that computes a processing execution completion time needed for the server device to execute the specific processing according to the request information received by the reception section, based on: a relationship equation indicating a relationship between the stipulated information stipulating the contents of the specific processing, a coefficient, and the processing execution completion time needed for the server device to complete execution of the specific processing; the past processing execution completion time and the stipulation information stored in the storage section; and the stipulation information included in the request information received from the reception section.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a network system including a client 10 and plural providers 24A, 24B, etc.

FIG. 2 is a block diagram of a relay server 18.

FIG. 3A is a diagram illustrating a relay program of a first exemplary embodiment.

FIG. 3B is a diagram illustrating a relay process of the first exemplary embodiment.

FIG. 4 is a diagram illustrating an execution request table 62 listing processing for which a processing execution time needs to be estimated.

FIG. 5A is a diagram illustrating a VM generation management table 64A.

FIG. 5B is a diagram illustrating a volume generation request management table 64B.

FIG. 6A is a diagram illustrating a VM generation time data table 66A of a provider A.

FIG. 6B is diagram illustrating a volume generation time data table 66B of a provider A.

FIG. 7A is a diagram illustrating a VM generation time coefficient table 68A of a VM of a provider A.

FIG. 7B is a diagram illustrating a volume generation time coefficient table 68B of a provider A.

FIG. 8 is a flowchart illustrating an example of relay processing executed by a relay server 18 of the first exemplary embodiment.

FIG. 9A is a diagram illustrating a VM generation request issued to a relay server 18 from a client 10 of the first exemplary embodiment.

FIG. 9B is a diagram illustrating details of a VM generation request issued to a relay server 18 from a client 10 of the first exemplary embodiment.

FIG. 10 is a diagram illustrating a VM generation request issued to a management server 26X in a provider from a relay server 18 of the first exemplary embodiment.

FIG. 11 is a diagram illustrating contents of a response issued to a relay server 18 from a management server 26X in a provider when a VM is created on a server inside the provider of the first exemplary embodiment.

FIG. 12A is a diagram illustrating contents of a response issued to a client 19 from a relay server 18 when a VM has been created on a server in a provider of the first exemplary embodiment.

FIG. 12B is a diagram illustrating detailed contents of a response issued to a client 19 from a relay server 18 when a VM has been created on a server in a provider of the first exemplary embodiment.

FIG. 13A is a diagram illustrating a VM generation time coefficient table 68A.

FIG. 13B is a diagram illustrating specific contents of a VM generation request.

FIG. 13C is a diagram illustrating an equation for finding a predicted execution time for VM generation.

FIG. 13D is a diagram in which a predicted execution time for VM generating is found by substituting specific values into an equation.

FIG. 14 is a flowchart illustrating an example of coefficient computation and update processing of a calculation equation that finds a predicted execution time for VM generation.

FIG. 15A is a diagram illustrating a VM generation time data table 66A.

FIG. 15B is a diagram illustrating an equation that finds a predicted execution time for VM generation.

FIG. 15C is a diagram illustrating a VM generation time coefficient table 68A.

FIG. 16A is a diagram illustrating a relay program of a second exemplary embodiment.

FIG. 16B is a diagram illustrating a relay process of the second exemplary embodiment.

FIG. 17 is a flowchart illustrating an example of relay processing executed by a relay server 18 of the second exemplary embodiment.

FIG. 18A is a diagram illustrating a VM generation request issued to a relay server 18 from a client 10 of the second exemplary embodiment.

FIG. 18B is a diagram illustrating details of a VM generation request issued to a relay server 18 from a client 10 of the second exemplary embodiment.

FIG. 19 is a diagram illustrating a VM generation request issued to the management server 26X in a provider from a relay server 18 of the second exemplary embodiment.

FIG. 20 is a diagram illustrating contents of a response issued to a relay server 18 from a management server 26X in a provider when a VM has been created on a server in the provider of the second exemplary embodiment.

FIG. 21A is a diagram illustrating contents of a response issued to a client 19 from a relay server 18 when a VM has been created on a server in a provider of the second exemplary embodiment.

FIG. 21B is a diagram illustrating details of contents of a response issued to a client 19 from a relay server 18 when a VM has been created on a server in a provider of the second exemplary embodiment.

### DESCRIPTION OF EMBODIMENTS

Detailed explanation follows regarding an example of an exemplary embodiment of technology disclosed herein with reference to the drawings.

### First Exemplary Embodiment

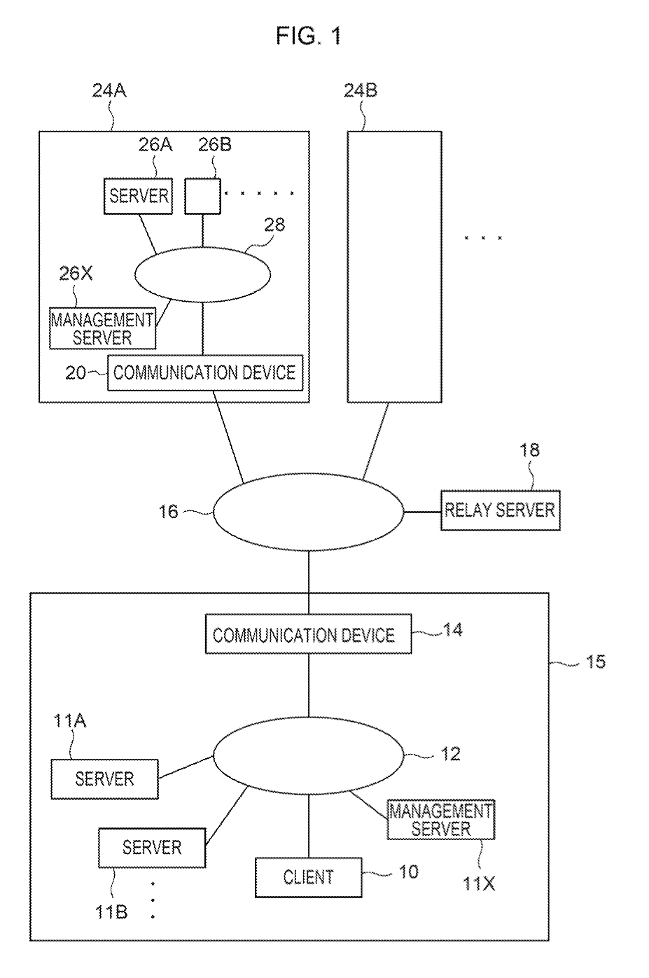

FIG. 1 illustrates a network system including a client device (referred to as a “client” hereafter) 10 and plural providers 24A, 24B, etc. The client 10 is connected to a local area network (LAN) 12. Plural servers 11A, 11B, etc. are connected to the LAN 12. The LAN 12 is connected to a network 16 such as the internet through a communication device 14. Note that the client 10 includes the servers 11A, 11B, etc., a management server 11X, and a local area network (LAN) 12, and is configured as a private cloud 15. FIG. 1 illustrates a single private cloud 15, and plural private clouds are connected to the network 16.

Plural providers 24A, 24B, etc., and a relay server 18 are connected to the network 16. Each of the providers corresponds to a public cloud.

Since the plural providers 24A, 24B, etc. are configured similarly to one another, explanation is given below regarding only the provider 24A, and explanation of the configuration of the other providers 24B, etc. is omitted. The provider 24A includes a LAN 28. A communication device 20, plural server devices (referred to as servers hereafter) 26A, 26B, etc., and a management server 26X are connected together in the LAN 28. The communication device 20 is connected to the network 16.

The servers 26A, 26B, etc. are examples of a “server device” of technology disclosed herein, the client 10 is an example of a “client device” of technology disclosed herein, and the relay server 18 is an example of a “relay device” of technology disclosed herein.

Since the client 10, the relay server 18, and the servers 26A, 26B, etc. are configured similarly to each other, explanation is given below regarding only the relay server 18, and explanation of the configuration of the client 10, and the servers 26A, 26B, etc. is omitted.

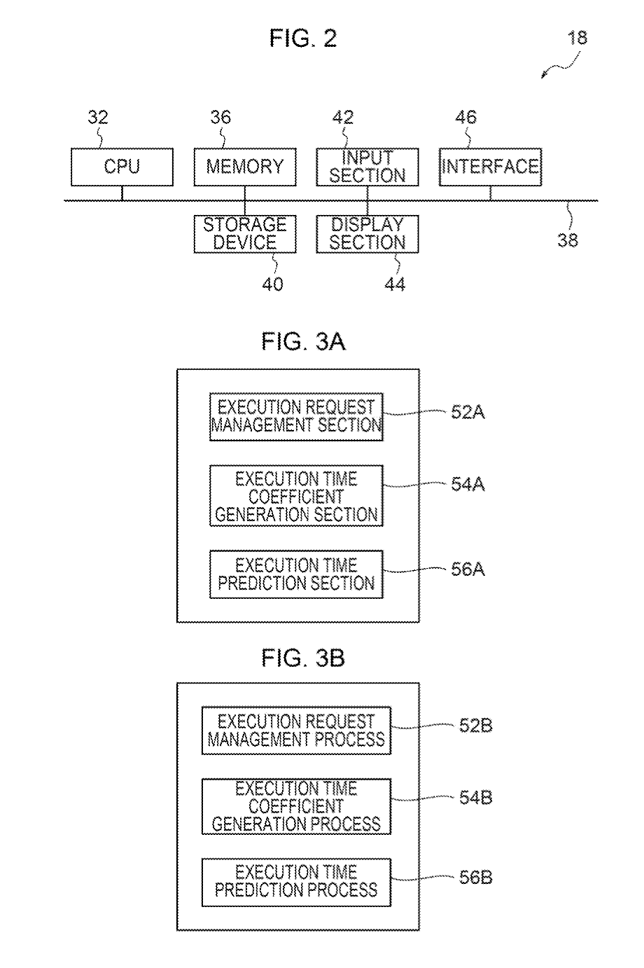

FIG. 2 illustrates a configuration of the relay server 18. As illustrated in FIG. 2, a central processing unit (CPU) 32 and memory 36 are connected together by the bus 38 in the relay server 18. A storage device 40, an input section 42, a display section 44, and an interface 46 are also connected to the bus 38. The interface 46 is connected to the network 16.

A relay program stored in the storage device 40 is illustrated in FIG. 3A, and relay processes are illustrated in FIG. 3B. The CPU 32 reads the relay program from the storage device 40, expands the relay program into the memory 36, and executes the relay processes included in the relay program. As illustrated in FIG. 3A, the relay program includes an execution request management section 52A, an execution time coefficient generation section 54A, and an execution time prediction section 56A. As illustrated in FIG. 3B, the relay program includes an execution request management process 52B, an execution time coefficient generation process 54B, and an execution time prediction process 56B. Note that the CPU 32 operates as each of the sections 52A to 56A by executing each of the processes 52B to 56B. The execution time coefficient generation section 54A and the execution time prediction section 56A are examples of a “computation section” of technology disclosed herein.

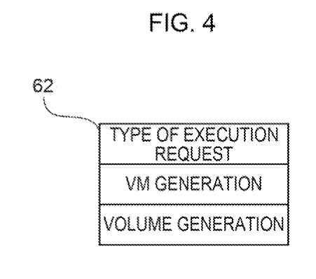

Various tables (FIG. 4 to FIG. 7), explained below, are stored in the storage device 40.

FIG. 4 illustrates an execution request table 62 displaying processes for which it is anticipated that the time taken from start to completion (predicted execution time) will be predicted. Virtual machine (VM) generation and volume (external virtual disk) generation are stored in the execution request table 62 as the above processing. Predicted execution times are only predicted for execution requests that appear in this table. Other execution requests are issued to the provider as they are. Note that examples of processing other than the above processing include VM migration, and VM backup.

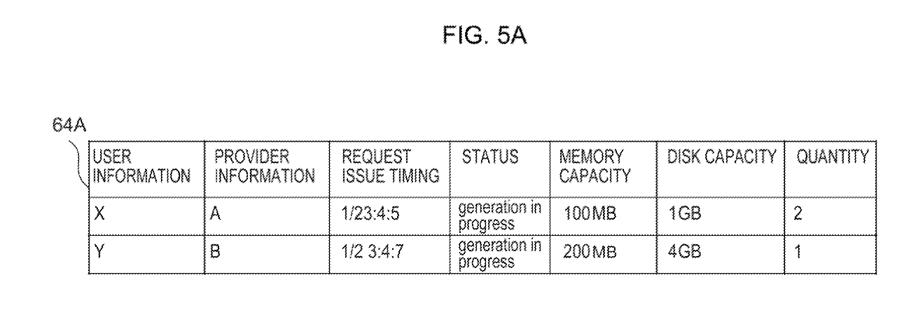

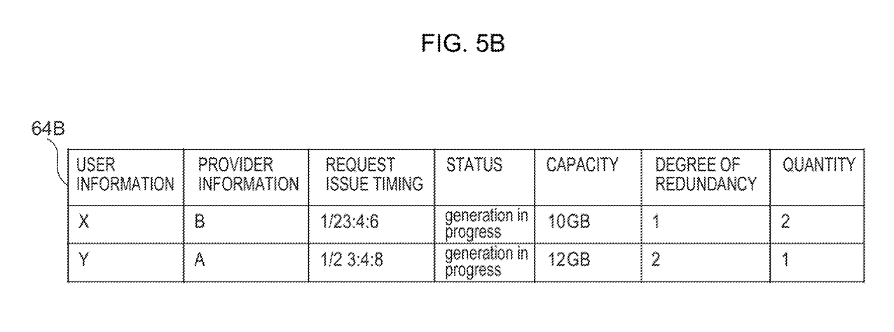

An execution request management table is illustrated FIG. 5A and FIG. 5B. The execution request management table includes a VM generation request management table 64A illustrated in FIG. 5A and a volume generation request management table 64B illustrated in FIG. 5B. The VM generation request management table 64A includes a user ID, user information such as authentication information, provider information such as the URL (address) of the provider and the ID of the VM, and a region for storing a corresponding request issue timing that is the timing at which the VM generation request was issued. The VM generation request management table 64A further includes a region for storing a state such as VM generation in progress, or VM generation complete. The VM generation request management table 64A further includes a region for storing memory capacities that are memory (primary storage device) capacities needed to migrate a VM in association with disk capacities that are disk (secondary storage device) capacities needed to migrate a VM. The VM generation request management table 64A includes a region for storing the quantity of VMs. The volume generation request management table 64B includes a region for storing the information of the user and the information of the provider in association with request issue timings that are timings at which volume generation requests were issued. The volume generation request management table 64B further includes a region for storing a state such as volume generation in progress, or volume generation complete. The volume generation request management table 64B further includes a region for storing, in association with each other, volume capacities, degree of redundancy that is a degree indicating how many copies of a volume to create as a damage counter-measure, and quantities of volumes.

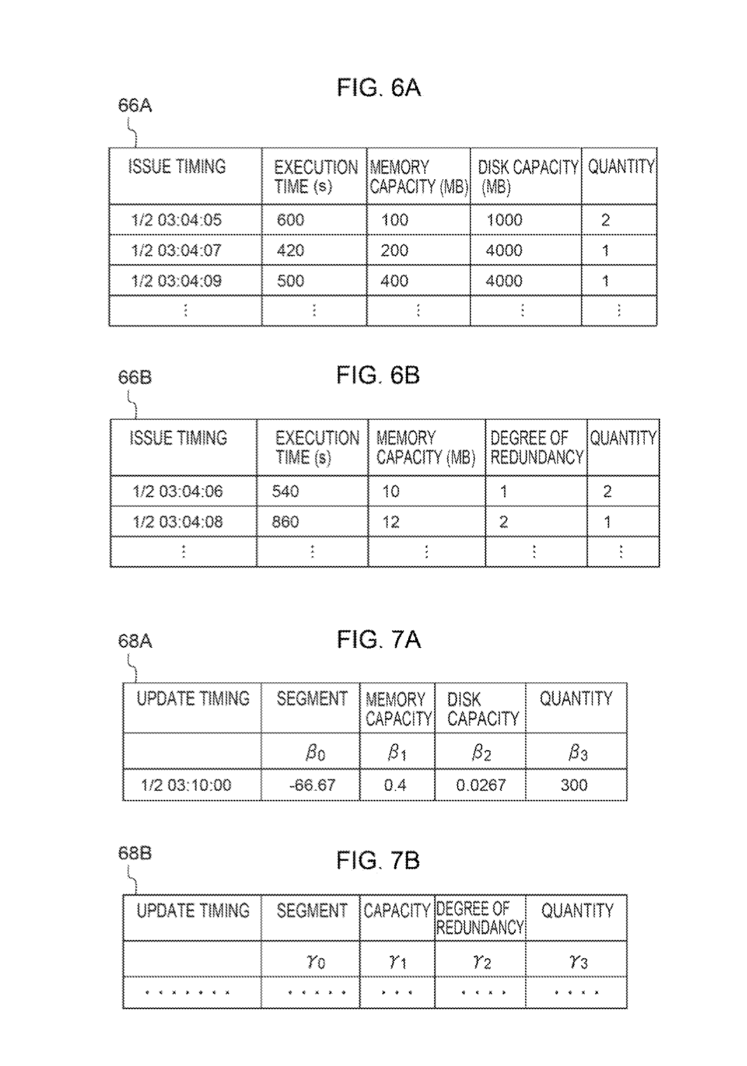

A table of data for execution times for each provider is illustrated in FIG. 6A and FIG. 6B. The execution time data table includes a table 66A of data for VM generation times in the provider 24A, illustrated in FIG. 6A, and a table 66B of data for volume generation times in the provider 24A, illustrated in FIG. 6B. The VM generation time data table 66A includes a region for storing issue timings at which a VM generation request was issued, execution times (s) that are times taken for VM generation, and memory capacities (MB) needed for VM migration. The VM generation time data table 66A further includes a region for storing disk capacities (MB) needed to migrate a VM, and quantities of the VM. The execution time is obtained by calculating the difference between the issue timing and the VM generation completion timing when VM generation completes. The volume generation time data table 66B includes a region for storing issue timings at which a volume generation request was issued, execution times (s) that are times taken for volume generation, and volume capacities (GB). The volume generation time data table 66B further includes a region for storing the degrees redundancy and the quantities.

The VM generation time data table 66A and the volume generation time data table 66B are examples of a storage section of technology disclosed herein. The execution times stored in the VM generation time data table 66A and the volume generation time data table 66B are examples of a “past processing execution completion time” of technology disclosed herein. The memory capacity (MB), the disk capacity (MB), and the quantity stored in the VM generation time data table 66A, and the volume capacity (GB), the degree of redundancy, and the quantity stored in the volume generation time data table 66B, are examples of “stipulated information” of technology disclosed herein.

A table of generation time coefficients for each provider is illustrated in FIG. 7A and FIG. 7B. The generation time coefficient table includes a table 68A of VM generation time coefficients of the provider 24A, as illustrated in FIG. 7A, and a table 68B of volume generation time coefficients of the provider 24A, as illustrated in FIG. 7B. The VM generation time coefficient table 68A includes a region for storing update timings, segments, memory capacities, disk capacities, and coefficients β₀ to β₃ corresponding to quantity. The volume generation time coefficient table 68B includes a region for storing update timings, segments, capacities, degrees of redundancy, and coefficients γ₀ to γ₃ corresponding to quantity.

Next, explanation follows regarding operation of the present exemplary embodiment.

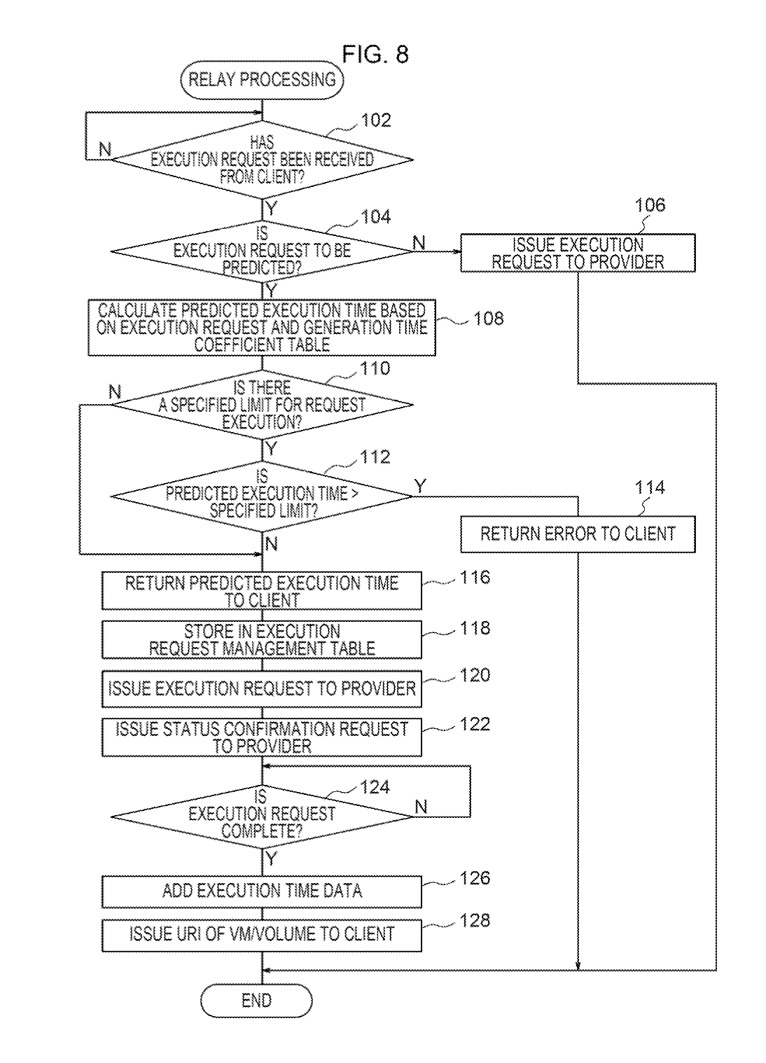

Sometimes a large volume of data is not analyzed in a short period of time using only VMs created on the servers 11A, 11B, etc. in the private cloud 15. The cloud user therefore attempts to create a VM on a server of one of the plural providers (in the public cloud) 24A, 24B, etc., for example, on one of the servers of the provider 24A. An execution request is therefore issued from the client 10. FIG. 8 illustrates an example of relay processing of an execution request executed by the relay server 18. At step 102 of FIG. 8, the execution request management section 52A determines whether or not an execution request was received from the client 10. Execution of the present step 102 is repeated in cases in which the determination result of step 102 is a negative determination.

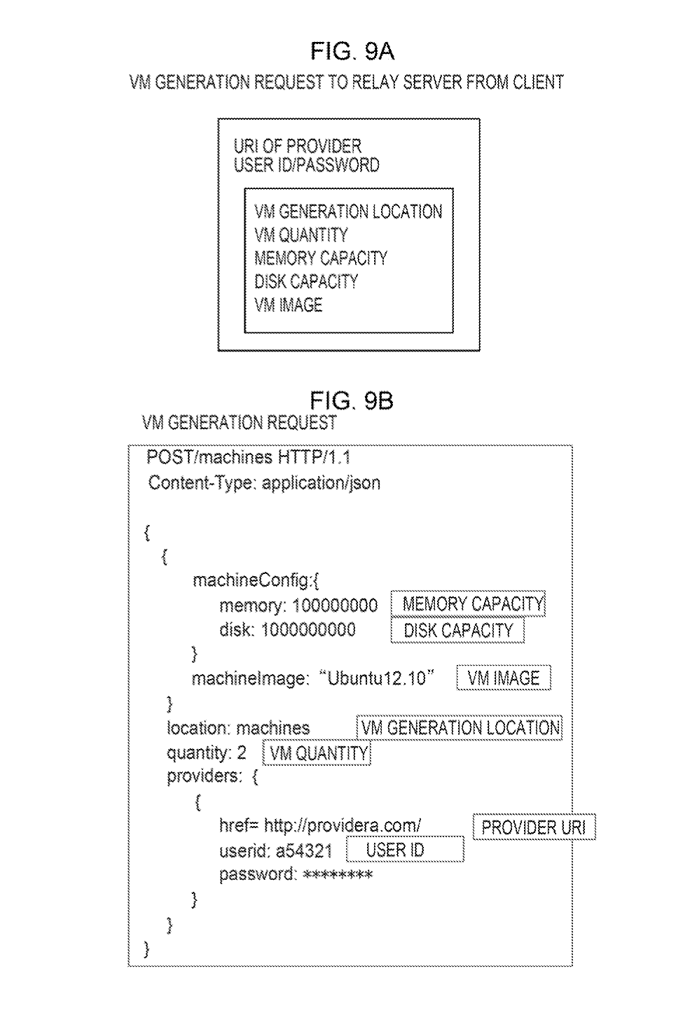

The cloud user uses the input section 42 of the client 10 to input VM generation data for the purpose of generating a VM on server of a provider selected from out of the plural providers 24A, 24B, etc., for example, on a server of the provider 24A. When the VM generation data has been input, the client 10 issues a VM generation request according to the API, as illustrated in FIG. 9A, and specifically as illustrated in FIG. 9B, to the relay server 18. As illustrated in FIG. 9A and FIG. 9B, the VM generation request includes the following data. Namely, the VM generation request includes a URI of the provider 24A, the ID and password of the user, a VM generation location (the provider 24A in the example above), the quantity of VMs, a memory capacity, a disk capacity, and a VM image (an operating system (OS) for running the VM). Note that the VM generation location (the provider 24A in the example above), the quantity of VMs, the memory capacity, the disk capacity, and the VM image (the OS for running the VM) are VM generation data. When the execution request management section 52A has determined that the VM generation request issued from the client 10 was received by the relay server 18, the determination result of step 102 is an affirmative determination, and the relay processing transitions to step 104.

There are users amongst the cloud users that do not consider it preferable that a great amount of time is needed to create a VM or volume on the selected provider 24A. To accommodate such users, the client 10 needs to be provided with an opportunity to erase the execution request and issue the execution request to another provider when a great amount of time is needed to create a VM or volume on the selected provider 24A. The maximum value (limit) for time taken to create the VM or volume on the selected provider 24A may be included in the VM generation data. When the limit is specified, the data of the specified limit is included in the execution request.

At step 104, the execution request management section 52A determines whether or not the execution request received from the client 10 is an execution request for which the predicted execution time is to be predicted. Namely, the execution request management section 52A determines whether or not the execution request received from the client 10 is an execution request for which the predicted execution time is to be predicted based on the execution request received from the client 10 and the execution request table 62 illustrated in FIG. 4. The determination result at step 104 is an affirmative determination when the execution request received from the client 10 is an execution request for VM generation or volume generation. When the execution request received from the client 10 is not present in the execution request table 62, the determination result of step 104 is a negative determination, and the relay processing transitions to step 106. At step 106, the execution request management section 52A issues the execution request to the management server 26X of the provider 24A.

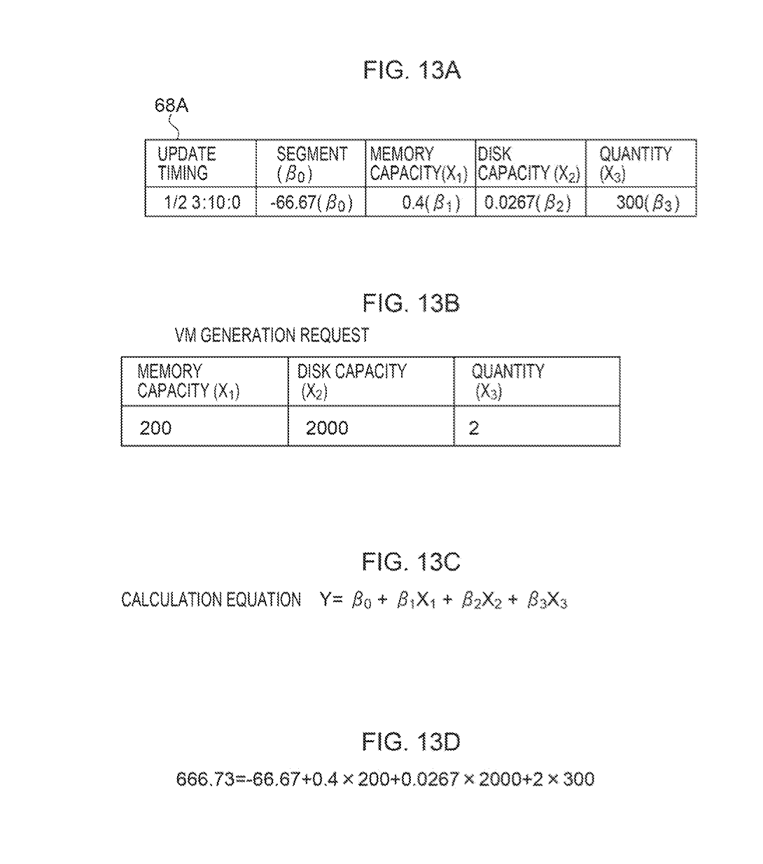

At step 108, the execution time prediction section 56A calculates the predicted execution time, based on the execution request received from the client 10 and the generation time coefficient table illustrated in FIG. 7A and FIG. 7B. Explanation follows regarding processing to calculate the predicted execution time, with VM generation serving as an example. As described below, a calculation equation (FIG. 13C) for finding the predicted execution time that is the time needed to create the VMs is predetermined Using this calculation equation, the predicted execution time is calculated from variables X₁ to X₃ that stipulate influences on the predicted execution time and that stipulate contents of VM and volume generation, and from the coefficients β₀ to β₄. A more detailed description is given below, but briefly, the coefficients β₀ to β₄ are calculated as illustrated in FIG. 13A. As illustrated in FIG. 13B, the memory capacity (X₁) is set to 200 (MB), the disk capacity (X₂) is set to 2000 (MB), and the quantity (X₃) is set to two in the execution request received from the client 10. When the respective values of the coefficients β₀ to β₄ (FIG. 13A) and the values of the variables (FIG. 13B) are substituted into the calculation equation (FIG. 13C), 666.73 (s) is calculated as the predicted execution time, as illustrated in FIG. 13D. The calculation equation is an example of “a relationship equation” of technology disclosed herein, and the contents of the processing of step 108 are an example of contents of “computing the processing execution completion time” of technology disclosed herein.

At step 110, the execution request management section 52A determines whether or not a limit (time) is included in the execution request from client 10. The limit (time) is an example of “a maximum value” of technology disclosed herein.

The relay processing transitions to step 116 when the determination result of step 110 is a negative determination. When the determination result of step 110 is an affirmative determination, at step 112, the execution request management section 52A determines whether or not the calculated predicted execution time is greater than the stipulated limit. When the determination result of step 112 is an affirmative determination result, the calculated predicted execution time is longer than that permitted by the cloud user. The cloud user considers the calculated predicted execution time to be undesirable. Therefore, at step 114, an error is returned (issued) to the client 10 indicating that the calculated predicted execution time is greater than the stipulated limit. After receiving the error, the client 10 displays the error on the display section 44. After seeing the error, the cloud user uses the client 10 to erase the execution request to create the VM or volume on the selected provider 24A, and issues the execution request to another provider.

The relay processing transitions to step 116 when the determination result of step 112 is a negative determination. At step 116, the execution request management section 52A returns the calculated predicted time to the client 10. After receiving the calculated predicted time, the client 10 displays the calculated predicted time on the display section 44.

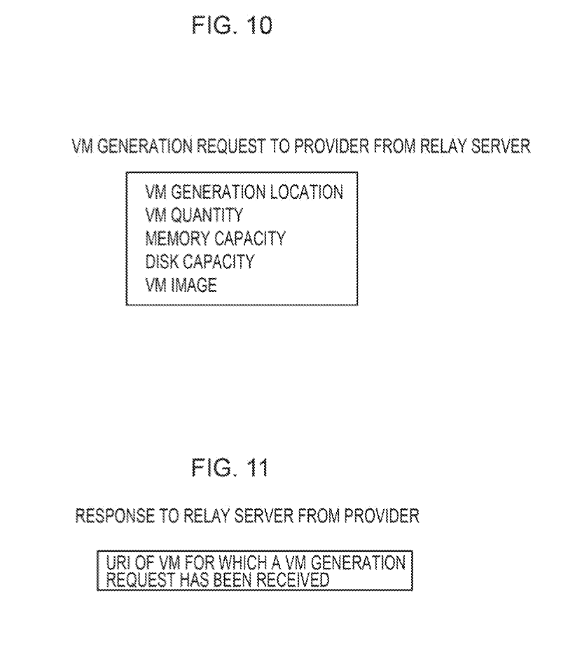

At step 118, the execution request management section 52A stores each item of data in the execution request management table (FIG. 5). For example, each item of data is stored in the VM generation management table 64A when the execution request was for VM generation, and each item of data is stored in the volume generation request management table 64B when the execution request was for volume generation. Note that at the present step 118, the VM generation in progress or volume generation in progress is stored in the region for storing the state. At step 120, the execution request management section 52A issues the execution request to the management server 26X of the provider 24A. Namely, for example, the VM generation request (FIG. 10) of contents corresponding to the VM generation request (FIG. 9) received from the client 10 is issued to the management server 26X when generation of a VM has been requested. The management server 26X issues the received VM generation request (FIG. 10) to the selected server, for example, the server 26A, out of the plural servers 26A, 26B, etc. A program for generating the VM is present on the server 26A, and the program creates the VM according to the received VM generation request.

At step 122, the execution request management section 52A issues a state confirmation request to the management server 26X of the provider 24A. When, for example, a VM has been created on the server 26A according to the VM generation request (FIG. 10), the management server 26X of the provider 24A issues the uniform resource identifier (URI) of the created VM illustrated in FIG. 11 to the relay server 18. Affirmative determination is thereby made at step 124, and at step 126, the execution request management section 52A adds the execution time data to the table of FIG. 6. The execution request management section 52A also updates an execution request management table 64 at the present step 126. Namely, VM generation complete is stored in the region of the VM generation management table 64A for storing the state when there has been an execution request for VM generation. VM volume generation complete is stored in the region of the volume generation request management table 64B for storing the state when there has been an execution request for volume generation.

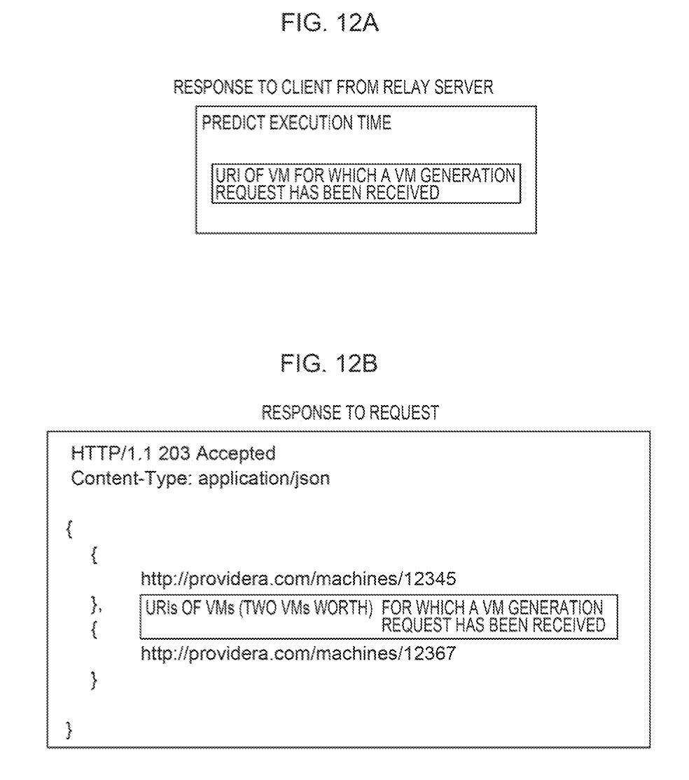

At step 128, the execution request management section 52A issues the VM/volume URI to the client 10. Namely, in the case of VM generation, the URI of the created VM, as illustrated in FIG. 12A, is issued to client 10, and more specifically in the format illustrated in FIG. 12B.

As explained above, the relay server 18 issues the calculated predicted execution time to the client 10 when no limit has been stipulated for the execution request, or when the predicted execution time is not more than the stipulated limit. The client 10 displays the calculated predicted execution time on the display section 44. The cloud user can thereby ascertain the predicted execution time and evaluate the server.

Moreover, the relay server 18 issues an error to the client 10 when the predicted execution time is longer than the stipulated limit. The client 10 displays the calculated error on the display section 44. There cloud user can thereby ascertain that the predicted execution time is longer than the stipulated limit. Thus, after seeing the error, the cloud user can use the client 10 to erase the execution request to create a VM or volume on the selected provider 24A, and to issue the execution request to another provider.

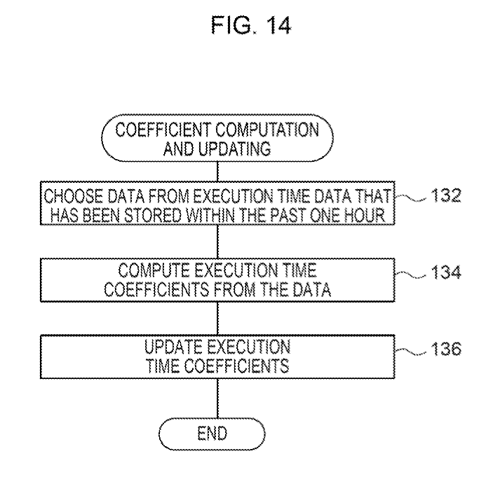

FIG. 14 illustrates an example of processing to compute and update the coefficients in the calculation equation for the predicted execution time. The processing for computing and updating is repeatedly executed after every interval of a fixed time. Note that the processing for computing and updating may be executed before step 108 in the relay processing (FIG. 8).

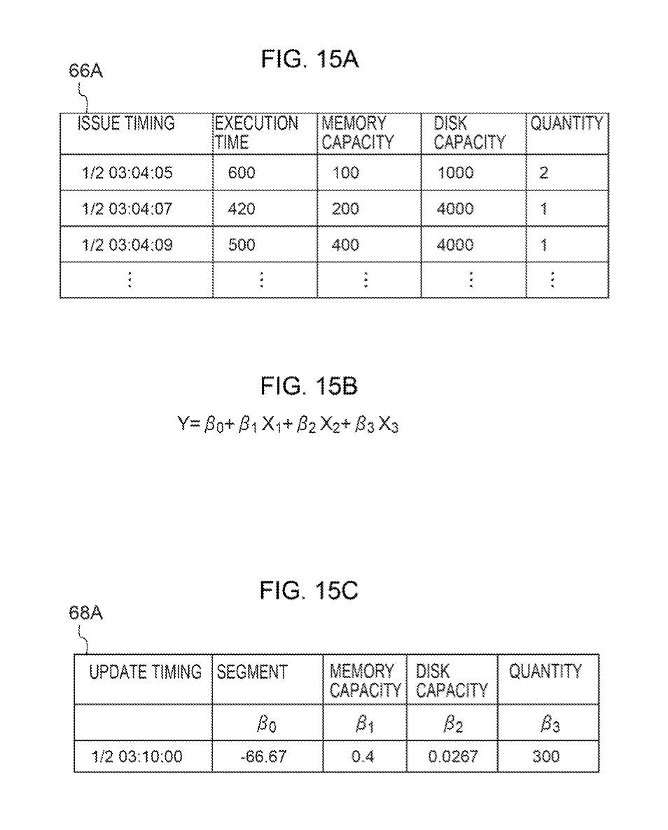

When the present processing starts, at step 132, the execution time coefficient generation section 54A chooses, for example, data from the execution time data table 66 (FIG. 6) that has been stored within the last one hour. At step 134, the execution time coefficient generation section 54A computes the execution time coefficients from the chosen data. At step 136, the execution time coefficients are updated. Further explanation follows regarding specific contents of the above processing, with reference to FIG. 15A to FIG. 15C.

At step 132, data is chosen from out of the data recorded in the execution time data table 66 illustrated in FIG. 6 that has been stored within 1 hour of the start time the present processing (FIG. 14). Namely, in cases in which the start time of the present processing (FIG. 14) was Jan. 2, 2013 04:04, data is chosen from the VM generation time data table 66A, as illustrated in FIG. 15A, that has been stored between Jan. 2, 2013 03:04 and Jan. 2, 2013 04:04. As described above, the equation for finding the predicted execution time for VM generation is predetermined as illustrated in FIG. 15B. The memory capacity (X₁), the disk capacity (X₂), and the quantity (X₃) are variables in the calculation equation. The coefficients β₀ to β₄ that associate the variables X₁ to X₃ indicating the influence on the predicted execution time with the predicted execution time are unknown numbers in the calculation equation. At step 134, the data chosen at step 132 is substituted into a regression model (multiple regression analysis) for the calculation equation. The coefficients β₀ to β₄ are calculated according to the least squares method so as to minimize the residual sum of squares. At step 136, the VM generation time coefficient table 68A is updated using the coefficients found in this manner, as illustrated in FIG. 15C.

The processing of step 134 is an example of contents of “computing a coefficient” of technology disclosed herein. The processing of step 136 is an example in which “for each computation of the processing execution completion time, the computed processing execution completion time is associated with the stipulation information . . . and stored in the storage section” of technology disclosed herein. One hour at step 132 is an example of a “fixed time” of technology disclosed herein.

The calculation equation explained above is an equation for finding the predicted execution time for VM generation. Although the equation for predicted execution time for volumes is similar to the calculation equation illustrated in FIG. 15B, the variables are the capacity (X₁), the degree of redundancy (X₂), and the quantity (X₃). The coefficients γ₀ to γ₄ are determined instead of β₀ to β₄. The coefficients for the volume predicted execution time are found similarly to in the method for finding the coefficients for the VM generation predicted execution time.

Note that one of the execution time data table 66 illustrated in FIG. 6 is provided to correspond to each of the providers. Each of the providers have plural servers. Thus in the execution time data table 66, the plural servers 26A, 26B, etc. provided to the provider 24A are handled as a single server in the execution time data table 66. Thus, the calculated coefficients are also stored in the coefficient table illustrated in FIG. 7 as if the plural servers 26A, 26B, etc. provided to the provider 24A are a single server.

Next, explanation follows regarding advantageous effects of the first exemplary embodiment.

Explanation follows regarding a first advantageous effect.

To facilitate understanding of the first advantageous effect, consider a client device that differs from the client device of the first exemplary embodiment and is unable to acquire VM generation performance of a server in the public cloud. The envisaged client device is unable to predict the time for VM generation on servers in the public cloud. Thus, although the user requesting VM generation wants to create a VM as soon as possible, the user is unable to determine which public cloud to use from out of plural public clouds for VM generation.

Moreover, in the public cloud, a VM generation request is received from an indeterminate client device. Thus the public cloud sometimes receives VM generation requests from many client devices. In such cases, the time needed for VM generation becomes longer as the number of received requests increases. Moreover, there may be cases in which some of the servers in the public cloud break down, and cases in which maintenance needs to be performed on each server in the public cloud. The time needed for VM generation is also longer than in a normal situation in these cases too. Thus, the client does not hold values for objectively evaluating each public cloud. From this viewpoint also, the requester of VM generation does not determine which public cloud to create the VM on from out of the plural public clouds.

VMs inside public clouds and private clouds can be technologically linked using an API in order to analyze large volumes of data in a short period of time. However, the advantage of using the public cloud to accelerate processing is not obtained since the requester of VM generation is unable to determine which public cloud to create the VM on out of the public clouds. Note that the above situation applies not only to VM generation, but also to VM migration and the like.

In the first exemplary embodiment, however, the cloud user is able to determine which provider out of the plural providers (public clouds) to make a request for VM generation to for the following reasons.

In the first exemplary embodiment, a calculation equation for finding the predicted execution time is predetermined The calculation equation includes the variables X₁ to X₃ that stipulate the contents of the processing, and the coefficients β₀ to β₄. The coefficients β₀ to β₄ are calculated from the data in the past execution time data table 66 (FIG. 6) and from the calculation equation. When there has been an execution request for processing such as VM or volume generation, the predicted execution time is calculated from the information of the variables stipulating the contents of processing, and coefficients included in the execution request, and from the equation. Thus, the first exemplary embodiment exhibits the first advantageous effect of enabling the cloud user to ascertain the predicted execution time even though VM and volume generation capacity of servers in the provider (in the public cloud) are not acquired. Thus the cloud user can determine which provider to request generation of a VM on from out of the plural providers (public clouds). Thus VMs in the public clouds and private clouds can be linked in practice using the API in order to analyze a large volume of data in a short period of time.

Explanation follows regarding a second advantageous effect. The predicted execution time is calculated as described above in the first exemplary embodiment. Thus the first exemplary embodiment has the second advantageous effect of enabling the user to ascertain how much time will be taken without needing to wait until execution of the processing completes.

Explanation follows regarding a third advantageous effect. An error is issued to the client 10 when the calculated predicted execution time is greater than the specified limit. The client 10 displays the error on the display section 44. This enables the cloud user to ascertain if the predicted time is longer than the specified limit. Thus, the first exemplary embodiment exhibits the third advantageous effect of enabling the cloud user to be provided with an opportunity to erase the processing execution request, and to resend the processing execution request to another provider 26B.

Explanation follows regarding a fourth advantageous effect. Data in the execution time data table 66 (FIG. 6) that has been stored within the last one hour is employed when calculating the coefficients β₀ to β₄. Namely, the coefficients β₀ to β₄ are calculated employing data close to the timing at which the client 10 attempts to cause the server to execute the processing. Data of within one hour is highly likely to reflect server statuses such as the following. Namely, a status in which many execution requests are being received by the provider, a status in which a temporary breakdown has occurred in a server of the provider, or a status in which a server of the provider is undergoing maintenance. Thus, the first exemplary embodiment exhibits the fourth advantageous effect of enabling the predicted execution time to be calculated according to the status of the server.

### Second Exemplary Embodiment

Next, explanation follows regarding a second exemplary embodiment. Since the configuration of the second exemplary embodiment is similar to that of the first exemplary embodiment, detailed explanation thereof is omitted. The operation of the second exemplary embodiment is in part similar to the operation of the first exemplary embodiment, and explanation of the parts that differ therefore follows.

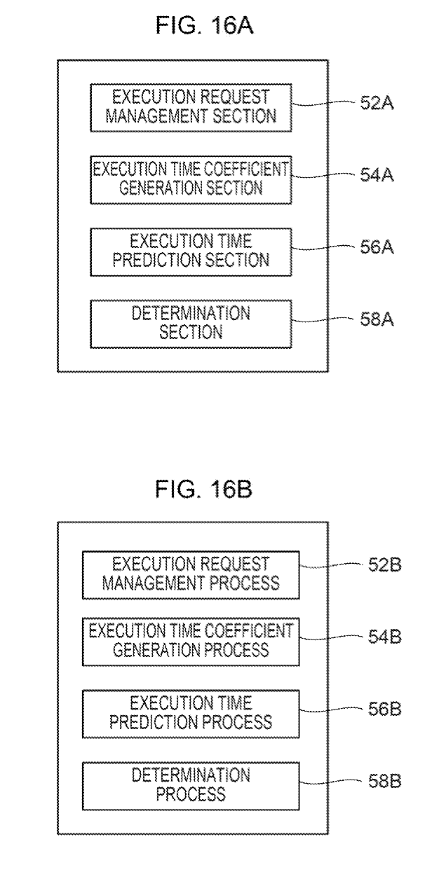

FIG. 16A illustrates a relay program. As is clear from comparison of FIG. 3A and FIG. 16A, the relay program of the second exemplary embodiment differs in that a determination section 58A is further included. A relay process is illustrated in FIG. 16B. As is clear from comparison of FIG. 3B with FIG. 16B, the relay process of the second exemplary embodiment differs in that a determination process 58B is further added.

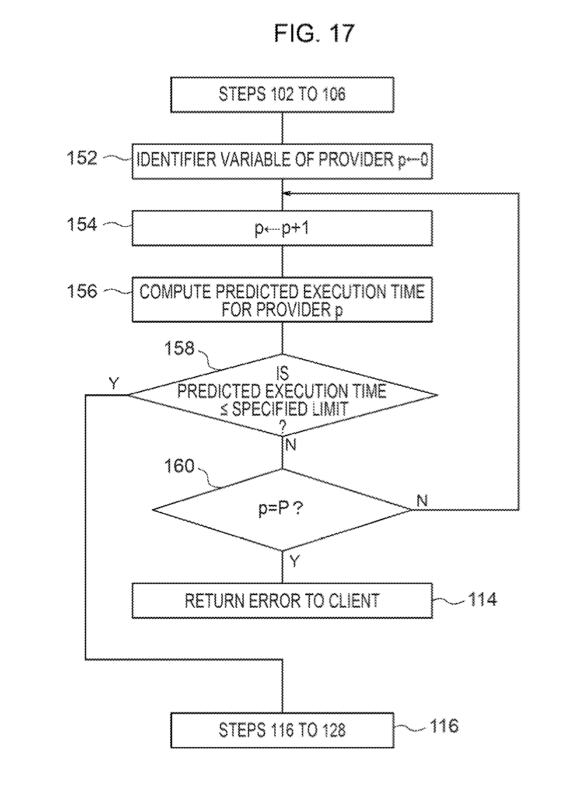

FIG. 17 illustrates an example of the relay processing of the second exemplary embodiment. As illustrated in FIG. 17, the processing of steps 102 to 106 of the first exemplary embodiment are executed in the example of the relay processing of the second exemplary embodiment. Instead of steps 108 to 112 of FIG. 8, steps 152 to 160 below are executed in the example of the relay processing of the second exemplary embodiment.

After the relay processing of the second exemplary embodiment has started and the processing of steps 102 to 106 has been executed, at step 152, the determination section 58A initializes an identifier variable p for identifying respective providers out of the plural providers 24A, 24B, etc. to 0. At step 154, the determination section 58A increments p by 1. At step 156, the determination section 58A calculates the predicted execution time for the provider p identified by the identifier variable p. Note that the calculation of the predicted execution time is similar to the calculation in the first exemplary embodiment, and explanation thereof is therefore omitted.

At step 158, the determination section 58A determines whether or not the specified limit is the calculated predicted execution time or greater. The processing of step 158 is an example of “determining whether or not the maximum value is the computed processing execution completion time or greater ” of technology disclosed herein.

When the determination result of step 158 is a negative determination, the predicted execution time for the provider p identified by the identifier variable p does not comply with the limit specified by the cloud user. Therefore, at step 160, the determination section 58A determines whether or not the identifier variable p is equal to the total number of providers P, and when the variable p is not equal to the total P, processing returns to step 154, and the above processing (steps 154 to 160) is executed.

When the determination result of step 158 is an affirmative determination, the predicted execution time for the provider identified by the identifier variable p complies with the limit specified by the cloud user. The relay processing therefore transitions to step 116, and steps 116 to 128 above are executed. Note that at step 120 of the second exemplary embodiment, the execution request is issued to the management server 26X of the provided identified by the identifier variable p.

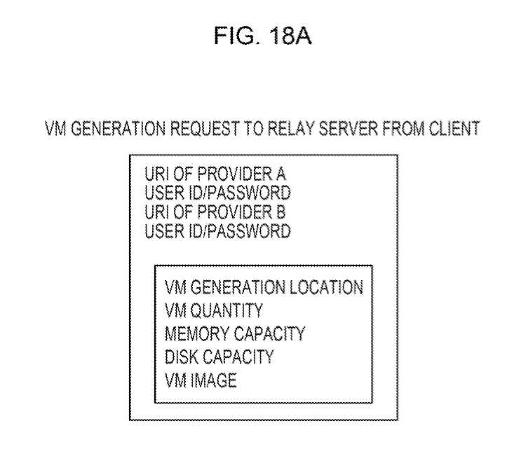

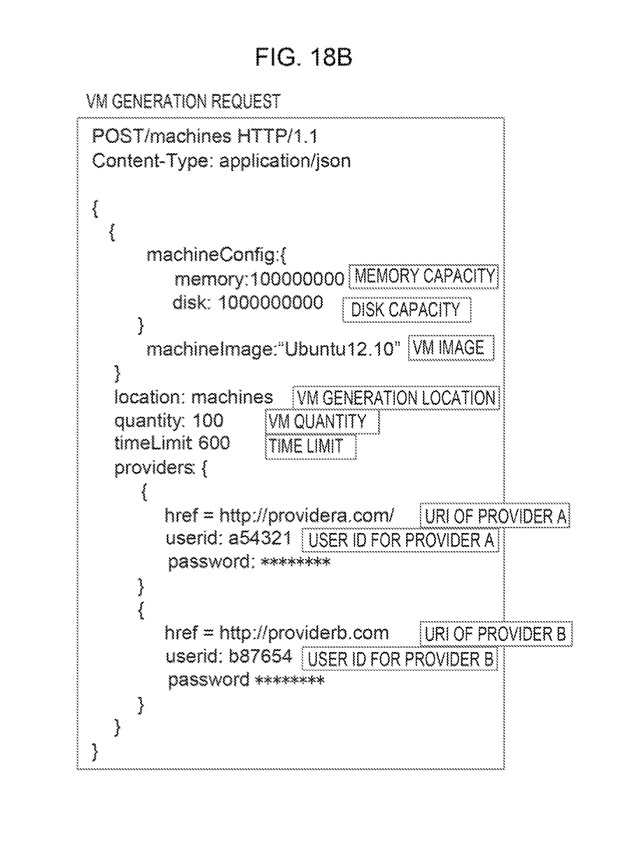

As illustrated in FIG. 18A and FIG. 18B, in comparison to the VM generation request of the first exemplary embodiment (FIG. 9), the VM generation request from the client 10 to the relay server 18 further includes the following contents. Namely, plural (for example, two) URIs of providers and an ID and password of the user for the respective providers are further included. As illustrated in FIG. 18B, a time limit is included in the second exemplary embodiment as the limit.

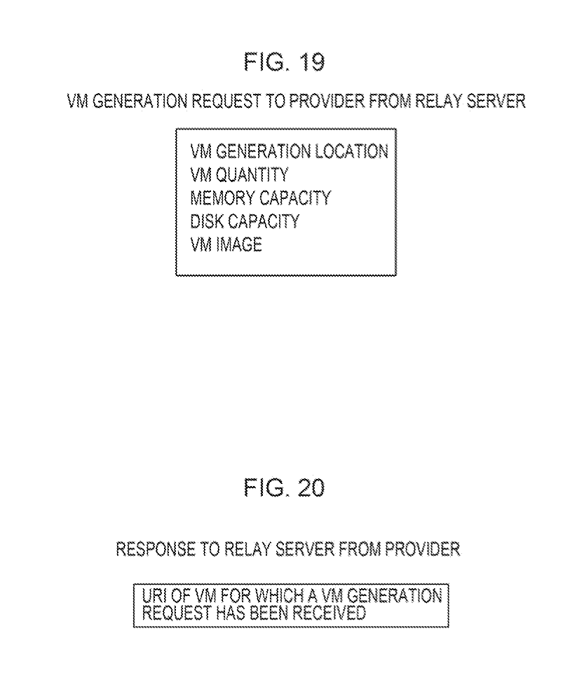

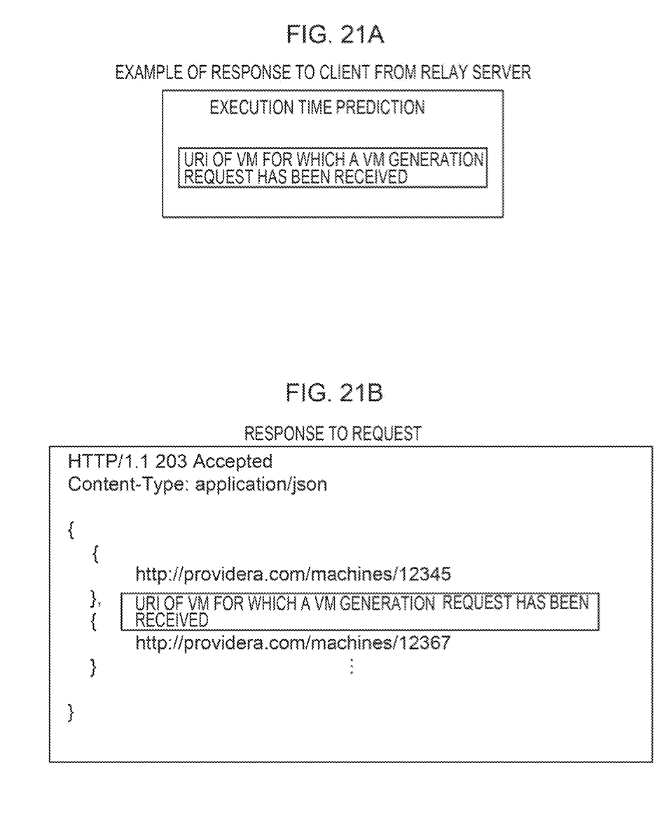

As illustrated in FIG. 19, the VM generation request from the relay server 18 to the provider is similar to the VM generation request of the first exemplary embodiment (FIG. 10). The response to the relay server from the provider and to the client from the relay (the URI received for the created VM (FIGS. 20-21B)) is also similar to in the first exemplary embodiment. Note that although a request was made to create two VMs in first exemplary embodiment, in the second exemplary embodiment, a request is made create 100 VMs.

Next, explanation follows regarding advantageous effects of the second exemplary embodiment. In the second exemplary embodiment, the predicted execution time is calculated for the provider p identified by the identifier variable p. When the calculated predicted execution time complies with the limit specified by the cloud user, an execution request is issued for processing such as VM generation to the provider p identified by the identifier variable p. Thus the second exemplary embodiment exhibits the advantageous effect of enabling processing of an actual request to be issued to a provider who, out of the plural providers, has a predicted execution time that complies with the specified time specified by the cloud user. Note that the second exemplary embodiment also exhibits the first to the fourth advantageous effects of the first exemplary embodiment.

Next, explanation follows regarding modified examples of the first exemplary embodiment and the second exemplary embodiment.

Explanation follows regarding a first modified example. As an example, explanation has been given in which VM or volume generation serves as the processing for which the predicted execution time is predicted in the first exemplary embodiment and the second exemplary embodiment. Technology disclosed herein is not limited to these examples. For example, the processing may be VM migration or backing up a VM.

Explanation follows regarding a second modified example. In the first exemplary embodiment and the second exemplary embodiment, data in the execution time data table 66 (FIGS. 6) that was stored within one hour is employed when calculating the coefficients β₀ to β₄. Technology disclosed herein is not limited to this example. For example, data in the execution time data table 66 (FIG. 6) corresponding to the ten most recent execution requests may be employed. The data corresponding to the ten most recent execution requests is an example of “the processing execution completion time and the stipulation information stored in the storage section until a fixed time passed from the time when the coefficient was computed or until the time when the processing execution completion time was computed a specific number of times previously”.

Explanation follows regarding a third modified example. In the first exemplary embodiment and the second exemplary embodiment, the memory capacity, the disk capacity, and the quantity are employed as variables in the calculation equation for finding the predicted execution time of the VM. However, sometimes the memory capacity and the disk capacity have little effect on the predicted execution time. A calculation equation employing the quantity alone may therefore be employed as the calculation equation for finding the predicted execution time of the VM.

Explanation follows regarding a fourth modified example. In the first exemplary embodiment and the second exemplary embodiment, regression analysis is employed to find the predicted execution time. However, another method may be employed in technology disclosed herein. For example, a coefficient of correlation may be employed. In such cases, first, Y=aX+b is employed as the calculation equation for the predicted execution time Y. Note that this equation is an equation of an example of applying to technology disclosed herein the third modified example for cases that consider the effect of the memory capacity and the disk capacity on the predicted execution time to be small, as described above. Correlation coefficients are employed to find a and b using the following equation.

$$a = \frac{{\sum }_{i = 1}^{n} ( {X}_{i} - \hat{X} ) ( {Y}_{i} - \hat{Y} )}{\sqrt{{\sum }_{i = 1}^{n} {( {X}_{i} - \hat{X} )}^{2}}} \\ b = \hat{Y} - aX \qquad Equation 1$$

More specifically, the execution time prediction section 56A finds the average predicted execution time as the average of Y, and the average quantity of VMs as the average of X. Next, the execution time prediction section 56A finds the covariance between X and Y as the numerator of the calculation Equation 1. Next, the execution time prediction section 56A finds the variance of X as the denominator of the calculation equation for a. The execution time prediction section 56A finds a and b from the above.

Explanation follows regarding a fifth modified example. In the first exemplary embodiment and the second exemplary embodiment, once the coefficients have been computed (FIG. 14), the coefficients are then employed when calculating the predicted execution time in the relay processing (FIG. 8). In technology disclosed herein, the predicted execution time can be calculated directly from the generation time data in FIG. 6A and FIG. 6B, information such as the quantity included in the execution request, and the following calculation equation. First, a calculation equation even simpler than the equation of the fourth modified example is employed. Namely, Y=aX is employed, wherein the predicted execution time is Y, the quantity is X, and the coefficient is a. The coefficient a is obtained from Y/X. Y and X when the generation time data of FIG. 6A and FIG. 6B are inserted are referred to as y and x. The calculation equation that directly calculates the predicted execution time is Y=(y/x)X. Thus the predicted execution time Y is directly calculated by inserting the generation time data of FIG. 6A and FIG. 6B as y and x of Y=(y/x)X, and inserting the quantity included in the execution request as X.

Next, explanation follows regarding a modified example made to only the second exemplary embodiment. In the second exemplary embodiment, when the predicted execution time for the provider p identified by the identifier variable p complies with the specified time specified by the cloud user, the execution request is issued for processing such as generation of a VM on the provider p identified by the identifier variable p. Technology disclosed herein is not limited to this example. For example, the predicted execution time may be calculated for all of the providers, and the processing execution request may be issued to the provider with the smallest calculated predicted execution time out of the predicted execution times that comply with the specified time specified by the cloud user.

All publications, patent applications and technical standards mentioned in the present specification are incorporated by reference in the present specification to the same extent as if the individual publication, patent application, or technical standard was specifically and individually indicated to be incorporated by reference.

Moreover, although explanation has been given of a mode in which the relay program is pre-stored (installed) on the storage device 40, the relay program according to technology disclosed herein may be provided in a mode recorded on a non-transitory recording medium such as a CD-ROM or a DVD-ROM.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it is understood that the various changes, substitutions, and alterations could be made hereto without departing from the spirit and scope of the invention.

1. A relay device that is disposed between a server device, that executes specific processing according to request information including stipulation information stipulating contents of the specific processing, and a client device, that issues the request information, and that relays the request information, the relay device comprising:
a storage section that stores a past processing execution completion time needed for the server device to complete execution of the specific processing, and stipulation information stipulating the contents of the specific processing corresponding to the past execution completion time;
a reception section that receives the request information; and
a computation section that computes a processing execution completion time needed for the server device to execute the specific processing according to the request information received by the reception section, based on:
a relationship equation indicating a relationship between the stipulated information stipulating the contents of the specific processing, a coefficient, and the processing execution completion time needed for the server device to complete execution of the specific processing;
the past processing execution completion time and the stipulation information stored in the storage section; and
the stipulation information included in the request information received from the reception section.

2. The relay device of claim 1, wherein
the computation section computes the coefficient based on the past processing execution completion time and the stipulation information stored in the storage section and based on the relationship equation, and computes the processing execution completion time based on the computed coefficient, the stipulation information included in the request information received by the reception section, and the relationship equation.

3. A relay method for relaying request information between a server device, that executes specific processing according to request information including stipulation information stipulating contents of the specific processing, and a client device, that issues the request information, the relay method comprising, by a processor:
storing in a storage section a past processing execution completion time needed for the server device to complete execution of the specific processing, and stipulation information stipulating the contents of the specific processing corresponding to the past execution completion time; and
computing a processing execution completion time needed for the server device to execute the specific processing according to the request information received by the server device, based on:
a relationship equation indicating a relationship between the stipulated information stipulating the contents of the specific processing, a coefficient, and the processing execution completion time needed for the server device to complete execution of the specific processing;
the past processing execution completion time and the stipulation information stored in the storage section; and
the stipulation information included in the received request information.

4. The relay method of claim 3, wherein
the coefficient is computed based on the past processing execution completion time and the stipulation information stored in the storage section and based on the relationship equation, and the processing execution completion time is computed based on the computed coefficient, the stipulation information included in the received request information, and the relationship equation.

5. The relay method of claim 4, wherein:
for each computation of the processing execution completion time, the computed processing execution completion time is associated with the stipulation information employed when computing the processing execution completion time, and stored in the storage section; and
when the coefficient is computed, the past processing execution completion time and the stipulation information are stored in the storage section until a fixed time passed from the time when the coefficient was computed, or until the time when the processing execution completion time was computed a specific number of times previously.

6. The relay method of claim 3, wherein:
the request information includes a maximum value of the processing execution completion time;
and the relay method further comprises determining whether or not the computed processing execution completion time is greater than the maximum value, and
in cases in which it is determined that the computed processing execution completion time is greater than the maximum value, issuing information indicating that the computed processing execution completion time is greater than the maximum value to the client device.

7. The relay method of claim 6, wherein
in cases in which it is determined that the computed processing execution completion time is not greater than the maximum value, the computed processing execution completion time is issued to the client device, and also the received request information is issued to the server device.

8. The relay method of claim 3, wherein
the computed processing execution completion time is issued to the client device, and the received request information is issued to the server device.

9. A relay method for relaying request information between a plurality of server devices that execute specific processing according to request information including stipulation information stipulating contents of the specific processing and a maximum value of processing execution completion time needed for execution of the specific processing to complete, and a client device that issues the request information, the relay method comprising, by a processor:
associating a past processing execution completion time needed for the server device to complete execution of the specific processing, and the stipulation information stipulating the contents of the specific processing corresponding to the past execution completion time, with the server device that executed the specific processing from among of the plurality of server devices, and storing the associated past processing execution completion time and stipulation information in a storage section;
computing the processing execution completion time needed for a selected server device to complete execution of the specific processing according to received request information based on:
a relationship equation indicating a relationship between the stipulation information stipulating the contents of the specific processing, a coefficient, and a processing execution completion time needed for the respective server device to complete execution of the specific processing;
the processing execution completion time and the stipulation information that have been associated with the selected server device out of the plurality of server devices and stored in the storage section; and
the stipulation information included in the received request information;
determining whether or not the maximum value is greater than or equal to the computed processing execution completion time; and
in cases in which the maximum value is determined to be greater than or equal to the computed execution completion time, issuing the request information to the selected server device.

10. The relay method of claim 9, wherein
the coefficient is computed based on the processing execution completion time and the stipulation information stored in the storage section and based on the relationship equation, and the processing execution completion time is computed based on the computed coefficient, the stipulation information included in the received request information, and the relationship equation.

11. The relay method of claim 9, further comprising
computing the processing execution completion time with a server device other than the selected server device out of the plurality of server devices as the selected server device in cases in which the maximum value was not determined to be greater than or equal to the computed processing execution completion timer.

12. The relay method of claim 9, further comprising
issuing, to the client device, information indicating that the processing execution completion times computed for all of the plurality of server devices are greater than the maximum value in cases in which the processing execution completion time computed for all of the plurality of server devices is determined to be greater than the maximum value.

13. The relay method of claim 9, further comprising:
issuing, to the client device, the computed processing execution completion time in cases in which the maximum value is determined to be the processing execution completion time or greater.

14. The relay method of claim 9, wherein
each of the plurality of server devices is provided in a different respective provider.

15. The relay method of claim 3, wherein:
the specific processing is generation of a virtual machine in the server device; and
the stipulation information at least includes a quantity of virtual machines to be created.

16. The relay method of claim 3, wherein:
the specific processing is generation of a virtual disk in the server device; and
the stipulation information includes at least a quantity of virtual disks to be created.

17. The relay method of claim 9, wherein:
the specific processing is generation of a virtual machine in the server device; and
the stipulation information includes at least a quantity of virtual machines to be created.

18. The relay method of claim 9, wherein:
the specific processing is generation of a virtual disk on the server device; and
the stipulation information includes at least a quantity of virtual disks to be created.

19. The relay method of claim 1, wherein:
the specific processing is generation of a virtual machine in the server device; and
the stipulation information is at least a quantity of virtual machines to be created.

20. The relay method of claim 1, wherein:
the specific processing is generation of a virtual disk in the server device; and
the stipulation information includes at least a quantity of virtual disks to be created.
